(19) United States
(12) Patent Application Publication
(10) Pub. No.: US 2014/0196854 A1
(43) Pub. Date: Jul. 17, 2014

(54) SEPARATING APPARATUS

(71) Applicant: E Ink Holdings Inc., Hsinchu (TW)

(72) Inventors: Tsung-Ting Lee, Hsinchu (TW); Chin-Chi Yu, Hsinchu (TW)

(73) Assignee: E Ink Holdings Inc., Hsinchu (TW)

(21) Appl. No.: 14/101,365

(22) Filed: Dec. 10, 2013

(30) Foreign Application Priority Data
Jan. 14, 2013 (TW) 102101357

(51) Int. Cl. B32B 43/00

(52) U.S. Cl. CPC B32B 43/006
USPC 156/752

(57) ABSTRACT

A separating apparatus, including a base and a wire, is provided. The base is adapted for carrying an electronic device. The electronic device includes a first substrate, a second substrate, and an adhesive layer. The adhesive layer adheres the first substrate and the second substrate to each other. The wire is configured on the base. A wire diameter of the wire is equal to or greater than a thickness of the adhesive layer.

### CROSS-REFERENCE TO RELATED APPLICATION

This application claims the priority benefit of Taiwan application serial no. 102101357, filed on Jan. 14, 2013. The entirety of the above-mentioned patent application is hereby incorporated by reference herein and made a part of this specification.

### BACKGROUND OF THE INVENTION

1. Field of the Invention

The invention relates to a separating apparatus and particularly relates to a separating apparatus for separating two substrates adhered to each other.

2. Description of Related Art

As the information technology industry advances, electronic products having multiple functions, such as display, touch control, and 3D display functions, are becoming more and more popular because they are highly convenient. At present, most of the electronic products with the multiple functions are achieved through plug-ins. For example, if an electronic device is required to provide display and touch control functions, the electronic device may be fabricated by adhering a touch panel to a display panel through an adhesive. It goes without saying that, in order to improve the display quality, a front-light module can be disposed and adhered before the display panel that provides the display function, e.g. electro phonetic display (EPD) panel or liquid crystal display (LCD) panel, to form the electronic device required.

When the components that constitute the electronic device need to be reworked or analyzed, it is usually required to separate the components. According to the conventional technique, the adhered components, such as the display panel and the touch panel, are placed on a separating apparatus and then wire-cut by a thin wire (having a line width less than the thickness of the adhesive) of the separating apparatus, so as to be separated from each other. When the thin wire cuts the adhesive, the thin wire is completely caught into the adhesive. Because there is greater friction between the thin wire and the adhesive, larger force is needed to cut and separate the adhesive. Moreover, when the thin wire wire-cuts the adhesive, residual adhesive may exist on the display panel or the touch panel. Additionally, the thin wire has lower strength. When a greater force is applied, breaking may occur and the costs may increase accordingly. Therefore, it is inconvenient and time-consuming to use the conventional separating apparatus to separate the components of the electronic device, and the conventional separating apparatus is not suitable for reworking.

### SUMMARY OF THE INVENTION

The invention provides a separating apparatus adapted for efficiently separating two substrates adhered to each other.

The separating apparatus of the invention includes a base and a wire. The base is adapted for carrying an electronic device. The electronic device includes a first substrate, a second substrate, and an adhesive layer. The adhesive layer adheres the first substrate and the second substrate to each other. The wire is configured on the base, wherein a wire diameter of the wire is equal to or greater than a thickness of the adhesive layer.

In an embodiment of the invention, the wire diameter of the wire is 2 to 15 times the thickness of the adhesive layer.

In an embodiment of the invention, the thickness of the adhesive layer is in a range of 0.01 to 0.3 mm.

In an embodiment of the invention, a material of the wire includes nylon, steel wire, metal, or a combination thereof

In an embodiment of the invention, the adhesive layer includes an optical adhesive layer, a liquid adhesive layer, or an optical adhesive layer with a substrate.

In an embodiment of the invention, the first substrate is a touch panel or a front-light module, and the second substrate is a display panel.

In an embodiment of the invention, the display panel includes a liquid crystal display panel, an electro phonetic display panel, or an organic light emitting display panel.

In an embodiment of the invention, the base is a heating base adapted to be heated to a working temperature.

In an embodiment of the invention, the working temperature is between a melting point of the adhesive layer and a softening temperature of the adhesive layer.

In an embodiment of the invention, the wire is adapted for being leaned against a side of the first or the second substrate that is adjacent to the adhesive layer, so as to peel off the adhesive layer from the first or the second substrate.

In an embodiment of the invention, the electronic device further includes a third substrate, and the adhesive layer includes a first adhesive layer, adhering the first substrate and the second substrate to each other, and a second adhesive layer, adhering the second substrate and the third substrate to each other. The first substrate is a front-light module, the second substrate is a touch panel, and the third substrate is a display panel.

Based on the above, because the wire in the separating apparatus of the invention has the wire diameter equal to or greater than the thickness of the adhesive layer of the electronic device, the separating apparatus easily separates the adhesive layer between the first substrate and the second substrate from the first substrate or the second substrate, saves time and effort during operation, and is conducive to reworking processes.

To make the aforementioned features and advantages of the invention more comprehensible, several embodiments accompanied with drawings are described in detail as follows.

### BRIEF DESCRIPTION OF THE DRAWINGS

The accompanying drawings are included to provide a further understanding of the invention, and are incorporated in and constitute a part of this specification. The drawings illustrate exemplary embodiments of the invention and, together with the description, serve to explain the principles of the invention.

FIG. 1 is a schematic view illustrating a separating apparatus and an electronic device according to an embodiment of the invention.

FIG. 2 is a schematic enlarged cross-sectional view illustrating the wire and the electronic device of the separating apparatus of FIG. 1.

FIG. 3 is a schematic cross-sectional view illustrating an electronic device according to an embodiment of the invention.

### DESCRIPTION OF THE EMBODIMENTS

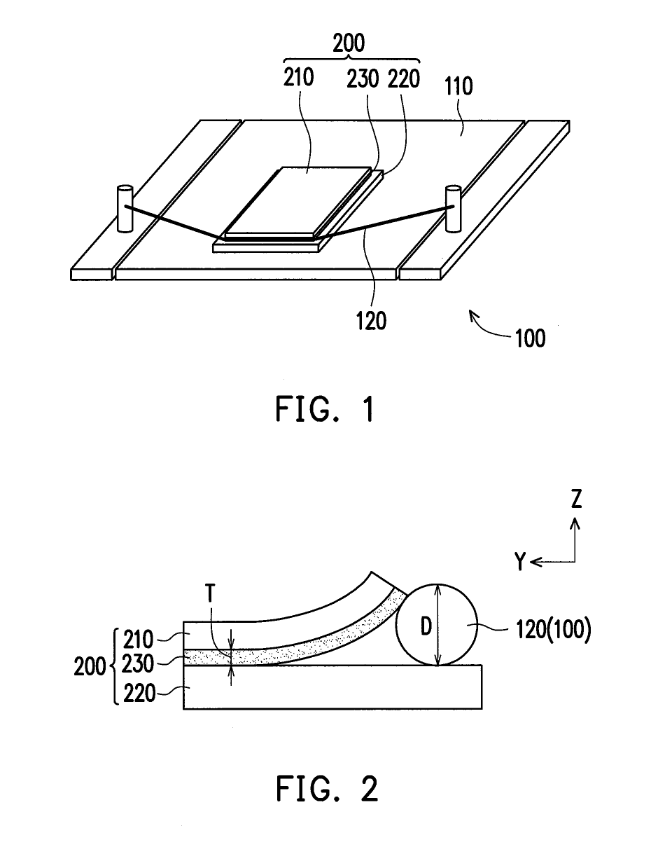

FIG. 1 is a schematic view illustrating a separating apparatus and an electronic device according to an embodiment of the invention. FIG. 2 is a schematic enlarged cross-sectional view illustrating the wire and the electronic device of the separating apparatus of FIG. 1. Referring to FIG. 1 and FIG. 2 at the same time, in this embodiment, a separating apparatus 100 includes a base 110 and a wire 120. The base 110 is suitable for carrying an electronic device 200. The electronic device 200 includes a first substrate 210, a second substrate 220, and an adhesive layer 230. The adhesive layer 230 adheres the first substrate 210 and the second substrate 220 to each other. The wire 120 is disposed on the base 110, wherein a wire diameter D of the wire 120 is equal to or greater than a thickness T of the adhesive layer 230.

To be more specific, in this embodiment, the first substrate 210 of the electronic device 200 is a touch panel or a front-light module, for example, and the second substrate 220 is a display panel, for example. The display panel is for example a liquid crystal display panel, an electro phonetic display panel, or an organic light emitting display panel; however, the invention is not limited thereto. The adhesive layer 230 is an optical adhesive layer, a liquid adhesive layer, or an optical adhesive layer with a substrate, for example; however, the invention is not limited thereto. The thickness T of the adhesive layer 230 is in a range of 0.01 to 0.3 mm, for example. Preferably, the wire diameter D of the wire 120 of the separating apparatus 100 is 2 to 15 times the thickness T of the adhesive layer 230. A material of the wire 120 includes nylon, steel wire, metal, or a combination thereof, for example.

Particularly, the wire 120 of the separating apparatus 100 of this embodiment is greater than or equal to the thickness T of the adhesive layer 230 of the electronic device 200. Thus, as shown in FIG. 2, the wire 120 is adapted for being leaned against a side of the second substrate 220 that is adjacent to the adhesive layer 230, so as to remove the adhesive layer 230 from the second substrate 220. That is, a force of the wire 120 is applied towards a Z direction to peel off a portion of the adhesive layer 230 and the second substrate 220, and then turned to a Y direction. Since the adhesive layer 230 has been peeled off and damaged, a resistance in the Y direction is significantly reduced, and as a result the subsequent adhesive layer 230 adhered to the second substrate 220 is separated quickly to complete the separation process of the second substrate 220 and the adhesive layer 230. Of course, in other embodiments not illustrated hereinafter, the wire 120 may be leaned against a side of the first substrate 210 that is adjacent to the adhesive layer 230, so as to remove the adhesive layer 230 from the first substrate 210. It is noted that the invention is not limited to the above disclosure.

In a word, the separating apparatus 100 of this embodiment uses the wire 120 that is thicker (relative to the adhesive layer 230 of the electronic device 200) to peel off and separate the adhesive layer 230 from the first substrate 210 or the second substrate 220 of the electronic device 200. When compared with the conventional thinner wire (that is thinner relative to the adhesive of the electronic device) which separates the components of the electronic device through wire-cutting, the wire 120 of the separating apparatus 100 of this embodiment saves time and effort during operation and is conducive to the reworking processes. Moreover, the wire 120 has stronger structural strength and does not break easily, and thus has higher structural reliability. In addition, after the wire 120 of the separating apparatus 100 of this embodiment separates the adhesive layer 230 from the first substrate 210 or the second substrate 220, residual adhesive is reduced.

It is worth mentioning that, in order to further improve the efficiency of the separating apparatus, the base 110 may be a heating base in other embodiments. More specifically, the heating base is adapted to be heated to a working temperature to soften the adhesive layer 230 disposed thereon, which helps the wire 120 to peel off the portion of the adhesive layer 230. Preferably, the working temperature is between a melting point of the adhesive layer and a softening temperature of the adhesive layer.

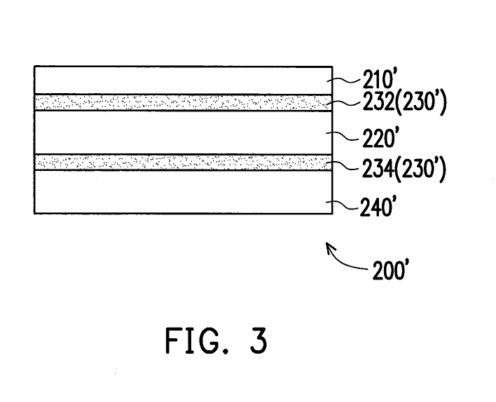

In addition, although the electronic device 200 disclosed here is embodied by combining the first substrate 210, the second substrate 220, and the adhesive layer 230, the structure of the electronic device 200 of the invention is not limited thereto. Referring to FIG. 3, in other embodiments, an electronic device 200′ may include a first substrate 210′, a second substrate 220′, a third substrate 240′, and an adhesive layer 230′, wherein the adhesive layer 230′ includes a first adhesive layer 232 and a second adhesive layer 234. The first adhesive layer 232 adheres the first substrate 210′ and the second substrate 220′ to each other. The second adhesive layer 234 adheres the second substrate 220′ and the third substrate 240′ to each other. The first substrate 210′ is a front-light module. The second substrate 220′ is a touch panel. The third substrate 240′ is a display panel. The above disclosure is one of the technical solutions of the invention and still falls within the scope of the invention.

In conclusion of the above, because the wire in the separating apparatus of the invention has the wire diameter equal to or greater than the thickness of the adhesive layer of the electronic device, the separating apparatus easily separates the adhesive layer between the first substrate and the second substrate from the first substrate or the second substrate, saves time and effort, and is conducive to reworking processes.

It will be apparent to those skilled in the art that various modifications and variations can be made to the invention without departing from the scope or spirit of the invention. In view of the foregoing, it is intended that the invention covers modifications and variations provided they fall within the scope of the following claims and their equivalents.

What is claimed is:

1. A separating apparatus, comprising:
a base carrying an electronic device comprising a first substrate, a second substrate, and an adhesive layer adhering the first substrate and the second substrate to each other; and
a wire configured on the base, wherein a wire diameter of the wire is equal to or greater than a thickness of the adhesive layer.

2. The separating apparatus as recited in claim 1, wherein the wire diameter of the wire is 2 to 15 times the thickness of the adhesive layer.

3. The separating apparatus as recited in claim 2, wherein the thickness of the adhesive layer is in a range of 0.01 to 0.3 mm.

4. The separating apparatus as recited in claim 1, wherein a material of the wire comprises nylon, steel wire, metal, or a combination thereof.

5. The separating apparatus as recited in claim 1, wherein the adhesive layer comprises an optical adhesive layer, a liquid adhesive layer, or an optical adhesive layer with a substrate.

6. The separating apparatus as recited in claim 1, wherein the first substrate is a touch panel or a front-light module, and the second substrate is a display panel.

7. The separating apparatus as recited in claim 6, wherein the display panel comprises a liquid crystal display panel, an electro phonetic display panel, or an organic light emitting display panel.

8. The separating apparatus as recited in claim 1, wherein the base is a heating base adapted to be heated to a working temperature.

9. The separating apparatus as recited in claim 8, wherein the working temperature is between a melting point of the adhesive layer and a softening temperature of the adhesive layer.

10. The separating apparatus as recited in claim 1, wherein the wire is adapted for being leaned against a side of the first or the second substrate that is adjacent to the adhesive layer, so as to peel off the adhesive layer from the first or the second substrate.

11. The separating apparatus as recited in claim 1, wherein the electronic device further comprises a third substrate, and the adhesive layer comprises a first adhesive layer, adhering the first substrate and the second substrate to each other, and a second adhesive layer, adhering the second substrate and the third substrate to each other, wherein the first substrate is a front-light module, the second substrate is a touch panel, and the third substrate is a display panel.
